(19) United States
(12) Patent Application Publication
(10) Pub. No.: US 2004/0186697 A1
(43) Pub. Date: Sep. 23, 2004

(54) Method and system for assisting in the planning of manufacturing facilities

(76) Inventors: Kurt Schreier, Schorndorf (DE); Carsten Skerra, Ludwigsburg (DE); Hans Kobschaetzky, Sachsenheim (DE)

Correspondence Address: KENYON & KENYON, ONE BROADWAY, NEW YORK, NY, 10004, US

(21) Appl. No.: 10/481,065

(22) PCT Filed: Jun. 12, 2002
(86) PCT No.: PCT/DE02/02118

(30) Foreign Application Priority Data
Jun. 13, 2001 (DE) 101 28 525.6

(51) Int. Cl. G06F 17/50

(52) U.S. Cl. 703/1; 700/97

(57) ABSTRACT

A method and a system for supporting the planning and design of manufacturing systems are described. In addition, an electronic unit and a computer program as well as a computer program product for carrying out the method are described. In the described method, the manufacturing system is represented as a digital model containing objects. This digital model is embedded in a simulation environment (80) for an analysis.

The present invention relates to a method, a system, and an electronic unit for supporting the planning and design of manufacturing systems. In addition, the present invention relates to a computer program and a computer program product for carrying out the method according to the present invention. The manufacturing systems in this case have at least one production apparatus.

### BACKGROUND INFORMATION

At present in the field of planning, design, and implementation of manufacturing systems, no consistent computer-aided working environments are supported. In individual cases detailed solutions are used, such as computer-aided design (CAD) or product data management (PDM) systems, but these neither completely describe the kinematics of machine systems nor take into account aspects of electrical engineering and sequence control.

Specifically in the area of planning and design, however, it appears reasonable to utilize simulation tools, in order to be sure even before the implementation that the system being designed meets the requirements. The use of a simulation tool is one means of doing this.

However, current simulation tools require complete prior modeling of the entire manufacturing system and its sub-systems to enable the performance of more advanced analyses. This is the case for example with packages for simulating robots, and also to a limited extent with machine tools in the area of milling.

### ADVANTAGES OF THE INVENTION

The method according to the present invention supports the planning and design of manufacturing systems. The manufacturing system is represented as a digital model containing objects. This digital model is embedded in a simulation environment for an analysis. It contains all the information needed for the simulation environment to simulate production apparatuses.

The simulation environment includes loading the objects from the digital model and various options for modeling. At the same time it constitutes the sequence environment for integrating and simulating control system elements, such as PLC controllers.

Preferably, the method also includes a function block for an engineering process, in which it is possible to represent production sequences, and with which process sequences and data flows are to be represented within the digital model using simulation technology. The engineering process thus includes the representation of a new process sequence that includes the use of simulation technology. At the same time it forms the flow of data within the digital model.

The digital model expediently contains additional information that is accessible for a working environment and is used by the latter to guide and manage specific and native data in the process sequence. This supports the engineering processes in the planning, design, and implementation of manufacturing systems.

In the formulation of the method according to the present invention, the digital model includes objects that contain geometry data, kinematic data, electrical properties, and control function blocks. The digital model may also show interrelationships among the objects, such as design-relevant, function-relevant, and/or sequence-relevant relationships.

Advantageously, in the method according to the present 5 invention a coupling to control systems is also carried out, so that the control systems exchange information with the represented production apparatuses. Thus not only real design data, but also original control programs of the machines are used. This integrates the aspects of modeling of sensors and actuators as well as standard-compliant denotation into a uniform, consistent database. The control systems utilized expediently correspond to the control systems used in real production apparatuses.

The system according to the present invention supports the planning and design of a manufacturing system having at least one production apparatus. The system includes a digital model containing the manufacturing system as objects, and a simulation environment in which the digital model is embedded.

The system is thus a digital model that contains all the information necessary for the simulation environment to simulate production apparatuses.

Also integrated into the formulation of the system according to the present invention is a function block for an engineering process, in which it is possible to represent production sequences, and with which process sequences and data flows are to be represented within the digital model using simulation technology.

The engineering process may be used to represent a process sequence, using simulation technology.

In this embodiment, the system represents a digital special machine (DSM), which provides a working environment for supporting the engineering processes when planning, designing, and implementing manufacturing systems. The DSM includes three function blocks, namely, the digital model, the simulation environment, and the engineering process.

The real production apparatuses are preferably represented in the DSM as a digital model, and are available in a simulation environment for additional analyses. The coupling to control systems enables early start-up of production apparatuses.

Additional preferred embodiments of the system according to the present invention may be seen from the dependent claims.

The electronic unit according to the present invention has an arithmetic unit and a memory device. A previously defined system is stored in the memory device. The arithmetic unit carries out a previously defined method.

The computer program includes program code means for carrying out the previously described method, and is executed on a computer or a corresponding arithmetic unit.

The computer program product is stored on a computer-readable data medium. Possibilities for suitable data media are EEPROMs and flash memories, but also CD-ROMS, diskettes, and hard disks.

Additional advantages and embodiments of the present invention may be seen from the detailed description and the accompanying drawing.

Naturally, the features named above and those remaining to be explained below are usable not only in the combination indicated in each case, but also in other combinations or individually, without departing from the scope of the present invention.

The present invention is represented schematically on the basis of an exemplary embodiment, and is described in detail in the following section in reference to the drawing.

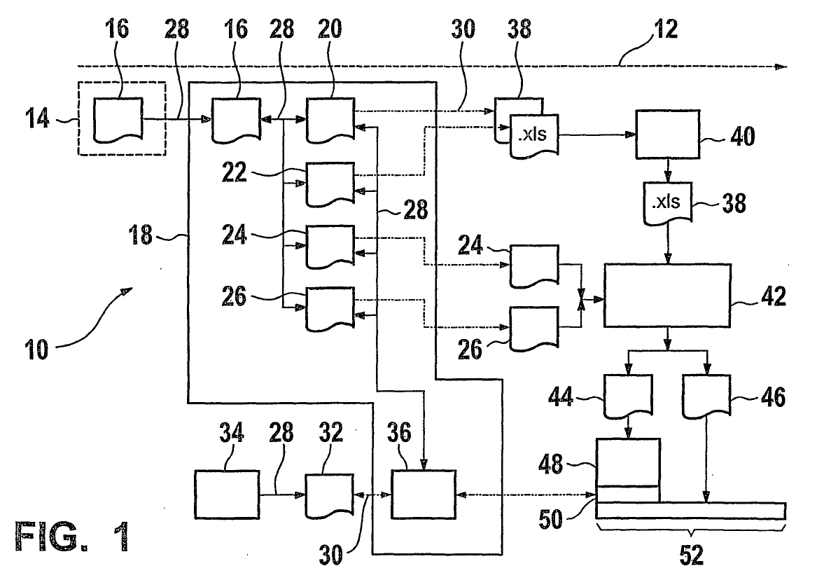

FIG. 1 shows a schematic view of a preferred embodiment of the system according to the present invention on the basis of a flow chart.

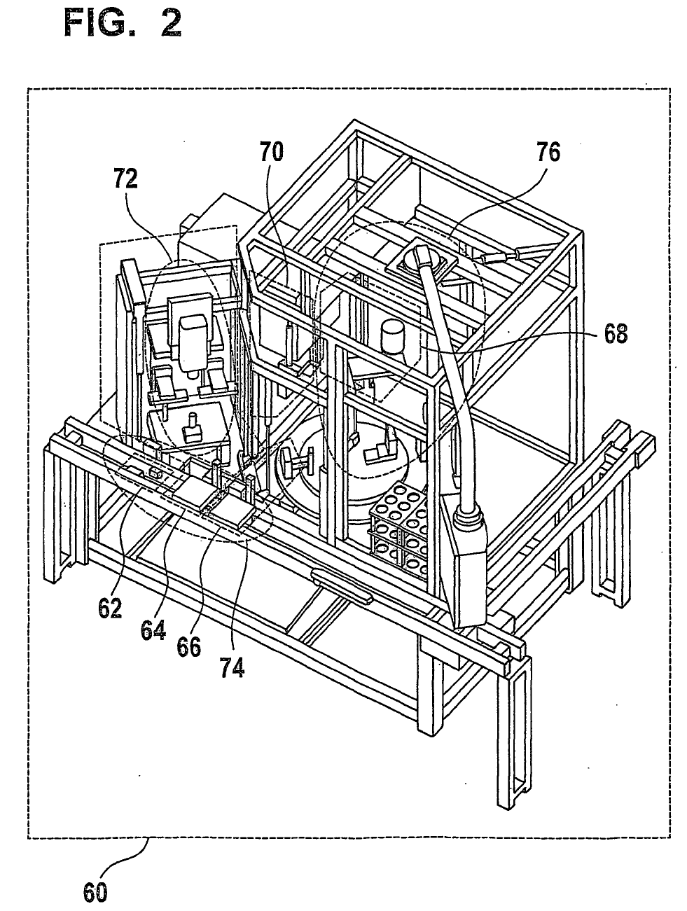

FIG. 2 shows a model of a manufacturing system.

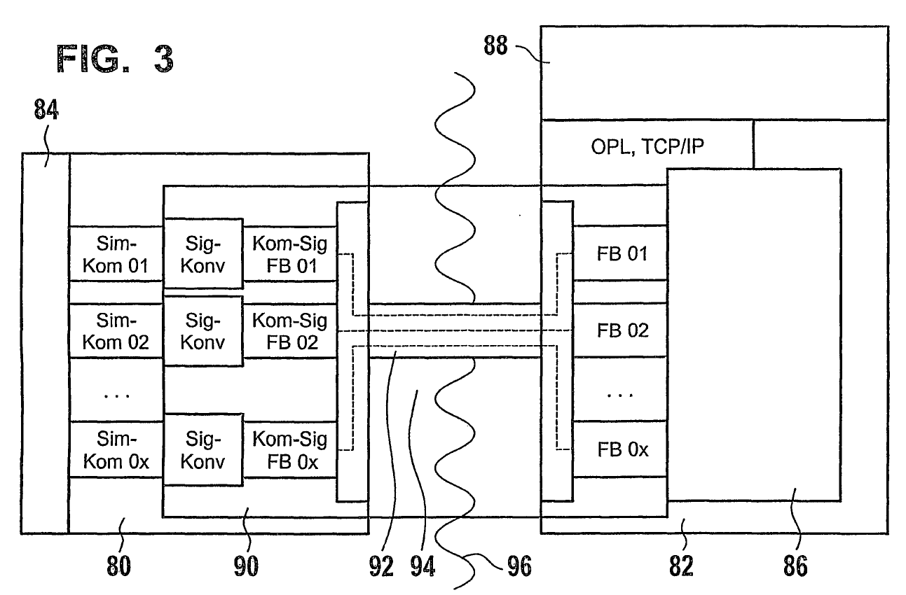

FIG. 3 shows a schematic representation illustrating an interface between a simulation model and a control concept.

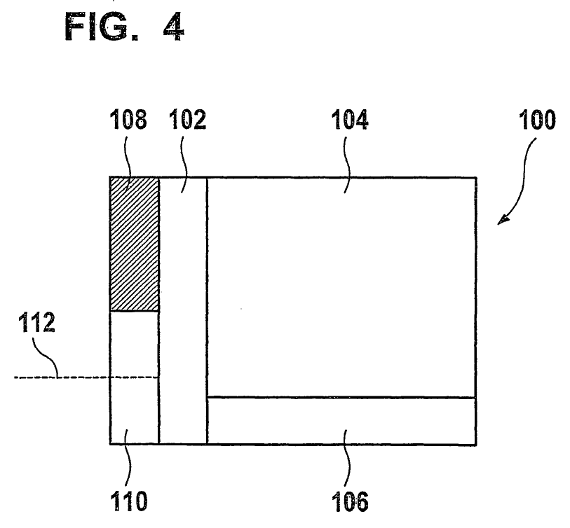

FIG. 4 illustrates a functional element from FIG. 3.

FIG. 1 represents a preferred embodiment of the system according to the present invention, designated in the aggregate by reference number 10, in a schematic representation. The representation illustrates software systems, interfaces to external systems, internal interfaces, objects of the digital model, and a software package of the digital special machine.

A dashed arrow 12 illustrates the sequence of the engineering process.

A first block 14 illustrates the mechanical planning phase. It contains an object 16 of the digital model, namely a technical overview. Another block 18 contains the mechanical design, i.e., the structure of the manufacturing system to be developed. It includes the objects of technical overview 16, basic diagram 20, circuit diagram 22, cycle time calculation 24, and flow chart description 26. Solid arrows 28 indicate internal interfaces. Dashed-dotted arrows 30 indicate interfaces to external systems.

The described objects, together with an object of CAD model 32, which is supplied by a software system PRO/E 34, are made available to a simulation tool 36. For the electrical coordination, objects 38 are provided for the electrical hardware and other objects for the electrical software, namely object 24 for the calculation of cycle time and object 26 for the flow chart description.

For processing objects 38 there is a software system EPLAN 40; its output, like objects 24 and 26, is input into a software system OpCon 42. This generates the objects PLC program 44 and OPLES program 46.

Object 44 is input into a software system code sysPLC 48, and the result of simulation tool 36 is input into a software system OPC 50. The result is a software system 52 that constitutes an executable simulated representation of the manufacturing system.

FIG. 2 portrays an example of a modeled manufacturing system as a functional unit 60. The illustration portrays a first work position 62, a second work position 64, a third work position 66, a fourth work position 68, and a fifth work position 70.

The illustration also depicts safety options, namely, reference number 72 designates “after emergency off and protective door 1,” reference number 74 designates “before emergency off,” and reference number 76 designates the safety option “after emergency off and protective doors 1 and 2.”

FIG. 3 represents an interface between a simulation model and a control concept “OpCon-Open Control.” The figure portrays a simulation computer 80 and a machine controller 82 in schematic form. Simulation computer 80 contains simulation model 84. Machine controller 82 includes a machine sequence program 86 and a user interface.88 of the controller.

Between the two blocks 80 and 82 is a protocol layer SimCom 90. This contains logical connections 92 and physical connections 94. In protocol layer 90, a communication level illustrated by a wavy line 96 is represented by TCP/IP.

A dedicated hardware element is used as simulation computer 80; it is responsible for the simulation of a machine model. At the same time, a possible three-dimensional visualization is to be treated initially as an additional function of this computer 80. The simulated machine model communicates with an original machine controller.

Machine controller 82 corresponds to a controller like those used in automation engineering for controlling machine functions. Controller 82 has essentially the run-time system that processes machine sequence program 86, the communication through various field bus systems with the hardware components (switches, drives, etc.), and the communication with a machine operator by way of an operator interface, namely a human machine interface (HMI).

Simulation computer 80 is connected at present physically via the Ethernet (TCP/IP) to machine controller 82. Logical connection 92 is implemented with protocol layer 90 “SimCOM,” which is the essential component of this interface.

Simulation model 84 contains the representation of the machine, with its individual components. The behavior of these individual components is simulated very abstractly. Interactions such as collisions occur, which are registered by the simulation environment and reported in the form of events. The evaluation and the processing of this information are normally carried out in the simulation environment using specific programming languages and controllers. These programming languages and controllers are usually not adequate to control a real machine, since the real-time demand placed on a machine controller, namely real-time capability, parallel processing, error handling, and industrial suitability, are not fulfilled. But this is also not the objective here, since only conceptual verifications of the model functions are involved.

At the level of software libraries, the simulation environment provides an access to the individual components. These are very abstract, and their behavior does not represent the basic elements of the automation components.

The module Sim-Kom, as a simulation component, represents the standardized interface to the simulation environment.

The module Sim-Kom0x must be created specifically for each simulation component; hence the enumeration 0x.

In protocol layer 90, SimCom, a module Sig-Kom, as signal converter, converts the behavior (trigger, event, states) of each individual component of simulation model 84 to an automation-conventional description, using inputs and outputs and their signals and signal profiles, including also signal edges.

A module Kom-Sig, as a component signal, models the behavior of the individual components in such a way that it corresponds to an original manufacturer-specific controller component. This is already geared to the functions of the function component on the machine controller side. A logical assignment is already defined at this time between the modules Kom-Sig FB0x and FB0x.

Machine controller 82 is the same hardware that is also responsible for controlling the real machine. Switching the communication channels to the field bus makes direct controlling of a machine possible. Machine sequence program 86 and the function components utilized no longer need to be modified. The simulation runs with the original control programs of the machine.

Operation of the machine in the various operating modes necessitates interventions by the machine operator or set-up person. To this end, machine controller 82 is given an additional operator interface 88 for operating and monitoring, for example in order to trigger individual functions of the machine.

Machine sequence program 86 controls the sequence of the machine, in particular in the automatic operating mode. The separation of the functional elements is not always clear. For example, the function elements may be influenced additionally by machine sequence program 86. Additional operating modes may be controlled by machine sequence program 86. Substantial parts are covered by the implementation of the functional elements, however.

Operator interface 88 and machine sequence program 86 communicate via current standards, such as TCP/IP and OPC (OLE for production control). These exchange the states between machine sequence program 86 and operator interface 88 via unique protocols. Reference should be made here to the software system OpCon.

FIG. 4 shows a schematic representation of a functional element FB0x, designated in the aggregate by the reference number 100. Functional element FB0x 100 defines at present the object-based view of individual manufacturer-specific automation components. This view is created only once and is used repeatedly; its programming supports the various operating modes required in the machine, as well as an error handling system and a defined communication with the machine sequence program and also to the interface.

The figure shows a block 102 for the input-output level controller. The input-output-level controller gives functional element 100 a new level for switching between the communication between field bus and the logical connection to module Kom-Sig FB0x as a component signal of a manufacturer-specific individual component. This switchover does not require any reprogramming above input-output-level controller 102, so that a switchover between real automation component and simulated automation component becomes possible. This has the effect that it is possible to connect individual real components during the test and operate the remaining components as a simulation.

Functional element 100 provides a block 104 for the Manual, Inching, and Automatic operating modes. An additional block 106 is provided for the additional mode Simulation. A shaded block 108 illustrates the diverse field bus connections, such as a CAN bus or process field bus. Another block 110 illustrates the SimCom protocol layer. A dashed line 112 illustrates the logical connection to the function block Kom-Sig FB0x.

The additional operating mode Simulation provides another level, which makes new functions possible within the framework of simulation engineering. These functions may be, for example, the reaction to errors triggered by the simulation model, a scenario manager that permits loading the current state of the machine into the simulation or the opposite, a representation of additional functions that are necessary for a virtual training component, i.e., for a tutorial for operating personnel on a virtual system to train for specific training or error cases.

What is claimed is:

1. A method for supporting the planning and design of a manufacturing system (60) having at least one production apparatus,
wherein the manufacturing system (60) is represented as a digital model (10) containing objects (16, 20, 22, 24, 26, 32, 38, 44, 46), and this digital model (10) is embedded in a simulation environment (80) for an analysis.

2. The method as recited in claim 1,
wherein in addition a function block for an engineering process is integrated, in which it is possible to represent production sequences, and with which process sequences and data flows are to be represented within the digital model (10) using simulation engineering.

3. The method as recited in claim 2,
wherein the digital model (10) contains additional information that is accessible for a working environment and is used by the latter to guide and manage specific and native data in the process sequence.

4. The method as recited in one of claims 1 through 3,
wherein the digital model (10) includes objects (16, 20, 22, 24, 26, 32, 38, 44, 46) that contain geometry data, kinematic data, electrical properties, and control function blocks.

5. The method as recited in one of claims 1 through 4,
wherein the digital model (10) also includes interrelationships among the objects (16, 20, 22, 24, 26, 32, 38, 44, 46).

6. The method as recited in claim 5,
wherein design-relevant relationships, function-relevant relationships, and sequence-relevant relationships are included in the digital model (10).

7. The method as recited in one of claims 1 through 6,
wherein a coupling to control systems is carried out and the control systems exchange information with the represented production apparatuses.

8. The method as recited in claim 7,
wherein the control systems correspond to the control systems used in real production apparatuses.

9. A system for supporting the planning and design of a manufacturing system (60) having at least one production apparatus, including a digital model (10) containing the manufacturing system (60) as objects (16, 20, 22, 24, 26, 32, 38, 44, 46) and a simulation environment (80) in which the digital model (10) is embedded.

10. The system as recited in claim 9,
wherein in addition a function block for an engineering process is integrated, in which it is possible to represent production sequences, and with which process sequences and data flows are to be represented within the digital model (10) using simulation engineering.

11. The system as recited in claim 10,
wherein the digital model (10) for supporting the engineering process contains additional information that is accessible for a working environment and is used by the latter to guide and manage specific and native data in the process sequence.

12. The system as recited in one of claims 9 through 11,
wherein the digital model (10) includes objects (16, 20, 22, 24, 26, 32, 38, 44, 46) that have geometry data, kinematic data, electrical properties, and control function blocks.

13. The system as recited in one of claims 9 through 12,
wherein the digital model (10) also includes interrelationships among the objects (16, 20, 22, 24, 26, 32, 38, 44, 46).

14. The system as recited in claim 13,
wherein design-relevant relationships, function-relevant relationships, and process-relevant relationships are contained in the digital model (10).

15. The system as recited in one of claims 9 through 14,
wherein a coupling to control systems is provided through which the control systems exchange information with the represented production apparatuses.

16. The system as recited in claim 15,
wherein the control systems correspond to the control systems used in real production apparatuses.

17. An electronic unit having an arithmetic unit and a memory device, a system as recited in one of claims 9 through 15 being stored in the memory device, and the arithmetic unit being used to carry out a method as recited in one of claims 1 through 8.

18. A computer program having program code means for carrying out all the steps of a method as recited in one of claims 1 through 8 when the computer program is executed on a computer or a corresponding arithmetic unit, in particular an electronic arithmetic unit as recited in claim 17.

19. A computer program product having program code means that are stored on a computer-readable data medium to carry out a method as recited in one of claims 1 through 8 when the computer program is executed on a computer or a corresponding arithmetic unit, in particular an electronic arithmetic unit as recited in claim 17.
